(19) United States
(12) Patent Application Publication
(10) Pub. No.: US 2008/0074286 A1
(43) Pub. Date: Mar. 27, 2008

(54) EMERGENCY VEHICLE ALERT SYSTEM AND METHOD FOR USING THE SAME

(76) Inventors: JASPAL S. GILL, SIMI VALLEY, CA (US); AJIT S. NARANG, NORTH HILLS, CA (US)

Correspondence Address: AJIT S. NARANG, 9925 GERALD AVENUE, NORTH HILLS, CA, 91343, US

(21) Appl. No.: 11/533,943

(22) Filed: Sep. 21, 2006

(51) Int. Cl. G08G 1/00

(52) U.S. Cl. 340/902

(57) ABSTRACT

An emergency vehicle alert system provides alerts to a client application that an emergency vehicle is on approach. The emergency vehicle alert system includes a transmitting device installed in an emergency vehicle and a receiving device installed in a client application. The transmitting device of the emergency vehicle triggers a response in the receiving device of the client application when the emergency vehicle is within a predetermined radius of the client application. The client application may be an automobile, portable music player, car stereo, GPS navigation system and/or a cellular telephone. The response triggered in these client applications includes a decrease in the volume and/or flashing of lights to notify the operator of the client application that an emergency vehicle is within a predetermined radius.

### FIELD OF THE INVENTION

Embodiments of the invention relate to early warning and/or notification alert systems, and, more particularly, to alert systems for use with emergency vehicles and client applications.

### BACKGROUND OF THE INVENTION

Emergency vehicles including police cars, fire engines, ambulances, and the like are currently equipped with audio and visual warnings systems to notify surrounding traffic of their approach. The Department of Motor Vehicles (DMV) mandates that drivers pull over to the right hand side of the road when emergency vehicles are in the vicinity. This allows the emergency vehicles to maneuver seamlessly through traffic and arrive at the destination in a timely manner. Time is of the essence in reaching the destination, requiring emergency vehicles to often run red lights, make illegal turns, and even drive on the wrong side of the road (i.e., on the left side in the US or the right side in the UK). To prevent potential traffic hazards, accidents and/or delays in reaching their destinations, alert systems have become integral in the design and manufacturing of emergency vehicles.

Currently, emergency vehicles are equipped with sirens, lights, bullhorns, and the like that provide notice to surrounding traffic of their approach. Drivers and pedestrians alike can vouch for the fact that these warning systems are effective. The loud piercing noise of the sirens varying in pitch and tone can be heard from great distances. The flashing red, white and blue lights can be seen from even greater distances. However, current audio and visual alert systems integrated in emergency vehicles greatly depend on how alert the surrounding drivers and pedestrians are, in addition to how quick their response is to the sounds of the sirens and images of the flashing lights. Even with these alert systems, police cars, fire engines and ambulances are continuously subjected to delays caused by the lagging response of surrounding traffic and pedestrians. These lagging delays have, in many instances, contributed to traffic accidents, delayed arrival to emergency situations and the like. The art is need for improvements and modifications to current alert systems.

### SUMMARY OF THE DISCLOSURE

According to an embodiment of the invention, an emergency vehicle alert system provides alerts to at least one client application that at least one emergency vehicle is on approach. In some embodiments, the emergency vehicle alert system includes a transmitting device installed in the at least one emergency vehicle and a receiving device installed in the at least one client application. In particular embodiments, the transmitting device of the at least one emergency vehicle triggers at least one response in the receiving device of the at least one client application when the at least one emergency vehicle is within a predetermined radius of the client application. In further embodiments the at least one client application is an automobile or a portable music player. In some embodiments, the at least one response triggered in the portable music player is a decrease in the volume of the portable music player. In still further embodiments the at least one client application is a car stereo installed in an automobile. In these embodiments, the at least one response triggered in the car stereo is a decrease in the volume of the car stereo. In other embodiments, the at least one client application is a GPS navigation system installed in an automobile or cellular telephone.

In other embodiments, the predetermined radius is between 0 and 10 miles. In still further embodiments the predetermined radius is above 10 miles. In additional embodiments, the at least one response triggered in the at least one client application is in the form of audio, visual and/or tactile feedback. In some embodiments, the at least one response in the client application is a combination of audio, visual and/or tactile feedback.

In still additional embodiments, an LED is installed on the at least one client application which, in some embodiments, cycles between the colors of red, yellow and green depending on the distance between the at least one client application and the at least one emergency vehicle. In other embodiments, the at least one client application is the steering mechanism of automobile which, in some embodiments vibrates when the at least one emergency vehicle is within the predetermined radius.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, where like numerals designate corresponding parts or cross-sections in the several figures.

FIG. 1 is a simplified schematic diagram of an embodiment of the emergency vehicle alert system.

### DETAILED DESCRIPTION OF THE PREFERRED EMBODIMENTS

As shown in the drawings for purposes of illustration, the invention is embodied in an emergency vehicle alert system with capabilities to notify surrounding traffic and pedestrians of their approach. In particular embodiments, the emergency vehicle alert system utilizes on board electronics of passenger vehicles to notify the driver of the passenger vehicle that an emergency vehicle is in the vicinity. In other embodiments, the emergency vehicle alert system relies on the electronics included in consumer electronic devices to notify pedestrians, construction workers, and the like that an emergency vehicle is in the vicinity.

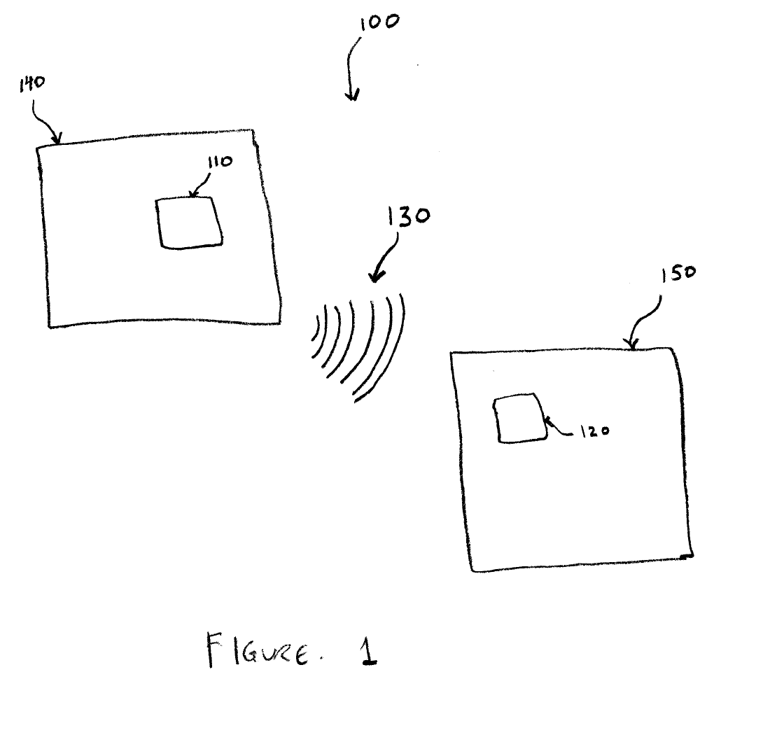

As illustrated in FIG. 1, embodiments of the emergency vehicle alert system 100 include a transmitting device 110 and a receiving device 120. In particular embodiments, the transmitting device 110 may be installed in emergency vehicles 140 including, but not limited to police vehicles, ambulances, fire engines, sheriff vehicles, security vehicles, and the like. In some embodiments, the transmitting device 110 may come pre-installed in the emergency vehicle 140 and, in other embodiments, the transmitting device 110 may be an upgrade that is installed in current emergency vehicles on the road today.

In these embodiments, the receiving device 120 may be installed in client applications 150 including, but not limited to, passenger vehicle on board electronics, car stereos, vehicle integrated digital audio players, portable digital audio players, vehicle integrated MP3 players, portable MP3 players, vehicle integrated GPS navigation systems, portable GPS navigation systems, mobile telephones, smartphones, personal digital assistants (PDAs), and the like. In some embodiments, the passenger vehicle on board electronics may include the dashboard interface, steering mechanism, and the like.

In particular embodiments, when the transmitting device 110 is activated by the operator of the emergency vehicle 140, the transmitting device 110 sends a signal 130 to all client applications 150 that are within a predetermined radius of the emergency vehicle's location. In some embodiments, the predetermined radius may be 100 feet. In other embodiments, the radius may range from 0 feet to 1000 feet. In still further alternative embodiments, the radius may range from 1000 feet to 10,000 feet. In still other embodiments, the radius may range from 10,000 feet to 10 miles. In some embodiments, the radius may be adjusted by the emergency vehicle operator depending on the circumstances of the emergency response. In other embodiments, the radius may be predetermined at the factory and not adjustable by the emergency vehicle operators. In still further embodiments, the radius may be predetermined by state and/or federal law based on governmental regulations. State and/or federal transportation agencies may also regulate the radius utilized in alert system.

In particular embodiments, the signal 130 alerts the user of the client application 150 that an emergency vehicle 140 is in the vicinity. The vicinity may be defined by the radius described above. In particular embodiments, the signal 130 causes a response in the client application 150. In some embodiments, depending on the type of client application 150 in use, the response may take multiple forms. For client applications that involve sound (i.e, car stereos, radios, MP3 players, and the like) the signal 130 may cause the volume on the client application 150 to decrease. This decrease in volume may allow the user of the client application 150 to take notice of the emergency vehicle's approach and take the appropriate action. For example, in the case of an operator of a passenger vehicle, the signal may cause the volume of the passenger vehicle's car stereo to decrease. In some embodiments, the volume decreases an incremental level. In other embodiments, the volume may be completely muted, and/or replaced by a vocal signal stating that an emergency vehicle is in the vicinity. In these embodiments, the volume may return to the previous listening level when the emergency vehicle 140 is no longer within the predetermined radius of the passenger vehicle. In other embodiments, the operator of the passenger vehicle may have to manually increase the volume back to a listening level.

In other embodiments, the client application may be in an automobile steering mechanism. In these embodiments, the driver receives a tactile response from the steering mechanism indicating that an emergency vehicle is in the vicinity. In other embodiments, the response in the client system may be a blinking light on the dashboard. In its most general form, the alert system would be used to notify a non-attentive person that an emergency vehicle is in the area. The non-attentiveness of the automobile operation, pedestrian, or any other person in the vicinity of the emergency vehicle may have been caused by listening to music in any form, talking on a phone, or just talking to another passenger in a passenger vehicle.

In particular embodiments, the transmitting device 110 included in the emergency vehicle 140 may be activated on demand by the driver of the emergency vehicle 140. In other embodiments, the transmitting device 110 may be activated when a separate, primary, or alternative alert system is activated. In these embodiments, the alert system of the present invention may be used in conjunction with a separate, primary or alternative alert system included on emergency vehicles. Current alerts systems include, but are not limited to sirens, flashing lights, bullhorns, and the like.

In still additional embodiments, the signal 130 may cause different responses in the client application 150. In these embodiments, the response in the client application 150 may be activation of an LED included in the client application. The activation of the LED may provide notice to the operator of the client application 150 that an emergency vehicle 140 is in the vicinity. In particular embodiments, the LED may be mounted on the dashboard of a passenger vehicle, mounted on the housing of a digital audio player, or the like. The LED may flash a single color to signify the approach of an emergency vehicle 140. In particular embodiments, the LED may flash. In other embodiments, the LED may turn on and remain on until the emergency vehicle leaves the radius of the client application 150. In still further embodiments, the LED may flash at different speeds or colors based on the distance of the emergency vehicle 140 (i.e., the LED may flash more rapidly, or flash red in color, as the emergency vehicle nears closer to the client application and/or the LED may flash slowly, or flash yellow in color as the emergency vehicle gets further away). In these embodiments a green color would signify that there are no emergency vehicles in the vicinity of the client application.

In some embodiments, the emergency vehicle alert system may include the capability to deactivate a normal response in a client application. For example, a client application may include a LED that is always on when no emergency vehicles are present. However, when an emergency vehicle was in the vicinity of the client application, the emergency vehicle alert system would send a signal to the client application and deactivate the LED that is normally on.

In still further embodiments, the response in the client application 150 may come in the form of a visual display. In these embodiments, the emergency vehicle alert system may utilize the LCD displays on current car stereos, MP3 players, dashboard odometer readouts, and the like to display a visual message that an emergency vehicle is within the vicinity. In other embodiments, SMS messages may be utilized to deliver a message to a cell phone user that an emergency vehicle is within the vicinity. When an SMS message is received by a cell phone, the normal response on the cell phone is a sound, vibration, or both to notify the user of the message. In these embodiments, the emergency vehicles would utilize a cellular phone's network to delivery emergency activity information to any and all cellular phones located within the vicinity. This system would cover all situations with cellular phone users, not just those using their cellular phones in their vehicles. Pedestrians and/or people in the surrounding areas on their cellular phones would also receive the SMS messages.

In still other embodiments, the emergency vehicle alert system 100 of the present invention may cause only a single response on the client application 150. In other embodiments, the system may cause multiple responses within the client application 150. Multiple responses may include, but are not limited to volume reduction, visual LED activation, visual message display, and the like. In some embodiments, the operator of the emergency vehicle 140 may choose which responses to activate within client applications 150 that fall within the radius of the emergency vehicle

In further embodiments, the response in the client application may come in the form of a voice prompt. For example, the vehicles electronics system may announce the following: “THERE IS AN EMERGENCY VEHICLE ON APPROACH”, or “An emergency vehicle is in the vicinity, please pull over to the right/left.” Many vehicles in currently being sold include voice automated systems that give instructions to automobile operator. Some examples include Honda, Acura, Toyota, Lexus, Mercedes and BMW vehicles all of which utilize a voice prompts to instruct the driver of directions when using GPS navigations systems. Multiple language support would also be included including, English, French, German, Swiss, Japanese, Chinese, Hindi, etc.

In still other embodiments, the client application may provide vibratory or tactile indication. In addition the tactile feedback on the steering mechanism explained above, other client applications may utilize the tactile indications including cellular phone, smartphone, PDAs, MP3 player, or the like.

In particular embodiments, the transmitting device 110 sends the signal 130 via RF communications. In other embodiments, the communication protocol may be through other means including, but not limited to infrared, Bluetooth, ZigBee, Wi-Fi, Wi-Max, Wi-Bro, cellular networks, beeper networks, and the like. Any form of wireless communications may be utilized by the transmitting device.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An emergency vehicle alert system for providing alerts to a client application that an emergency vehicle is on approach, the emergency vehicle alert system comprising:
at least one transmitting device installed in at least one emergency vehicle; and
at least one receiving device installed in at least one client application,
wherein the at least one transmitting device of the at least one emergency vehicle triggers at least one response in the at least one receiving device of the at least one client application when the at least one emergency vehicle is within a predetermined radius of the at least one client application.

2. The emergency vehicle alert system of claim 1, wherein the at least one client application is an automobile.

3. The emergency vehicle alert system of claim 1, wherein the at least one client application is a portable music player.

4. The emergency vehicle alert system of claim 3, wherein the at least one response triggered in the portable music player is a decrease in the volume of the portable music player.

5. The emergency vehicle alert system of claim 1, wherein the at least one client application is a car stereo installed in an automobile.

6. The emergency vehicle alert system of claim 5, wherein the at least one response triggered in the car stereo is a decrease in the volume of the car stereo.

7. The emergency vehicle alert system of claim 1, wherein the at least one client application is a GPS navigation system installed in an automobile.

8. The emergency vehicle alert system of claim 1, wherein the at least one client application is a cellular telephone.

9. The emergency vehicle alert system of claim 1, wherein the predetermined radius is between 0 and 10 miles.

10. The emergency vehicle alert system of claim 1, wherein the predetermined radius is above 10 miles.

11. The emergency vehicle alert system of claim 1, wherein the at least one response triggered in the at least one client application is in the form of audio feedback.

12. The emergency vehicle alert system of claim 1, wherein the at least one response triggered in the at least one client application is in the form of visual feedback.

13. The emergency vehicle alert system of claim 1, wherein the at least one response triggered in the at least one client application is in the form of tactile feedback.

14. The emergency vehicle alert system of claim 1, wherein the at least one response triggered in the at least one client application is a combination of audio, visual and/or tactile feedback.

15. The emergency vehicle alert system of claim 1, wherein an LED is installed on the at least one client application.

16. The emergency vehicle alert system of claim 15, wherein the LED cycles between the colors of red, yellow and green depending on the distance between the at least one client application and the at least one emergency vehicle.

17. The emergency vehicle alert system of claim 1, wherein the at least one client application is the steering mechanism of automobile.

18. The emergency vehicle alert system of claim 16, wherein the steering mechanism vibrates when the at least one emergency vehicle is within the predetermined radius.
